(19) United States
(12) Patent Application Publication
(10) Pub. No.: US 2011/0115833 A1
(43) Pub. Date: May 19, 2011

(54) PORTABLE TERMINAL AND LUMINANCE ADJUSTMENT PROGRAM

(75) Inventor: Yoshiyuki SHIMOYAMA, Kawasaki (JP)

(73) Assignee: FUJITSU LIMITED, Kawasaki-shi (JP)

(21) Appl. No.: 12/948,748

(22) Filed: Nov. 17, 2010

(30) Foreign Application Priority Data
Nov. 18, 2009 (JP) 2009-263389

(51) Int. Cl. G09G 5/10

(52) U.S. Cl. 345/690

(57) ABSTRACT

A portable terminal having a camera includes a display unit which displays an image captured by the camera, the display unit is located so that an exposure range illuminated with display light of the display unit and at least a part of an capturing range captured by the camera overlap each other, a display image generating unit which generates a display image having a luminance which is higher than the luminance of the captured image, while maintaining the form of a subject in the captured image and a display control unit which controls to display the display image in the display unit.

### CROSS-REFERENCE TO RELATED APPLICATIONS

This application is based upon and claims the benefit of priority of the prior Japanese Patent Application No. 2009-263389, filed on Nov. 18, 2009, the entire contents of which are incorporated herein by reference.

### FIELD

The present invention relates to a portable terminal and a luminance adjustment program.

### BACKGROUND

Recently, a portable terminal with a camera function has been widely used. The portable terminal means, for example, a cell/portable phone, a laptop computer, a portable game machine, and the like. The cell phone is available in the form of a portable terminal with a camera function.

Recently, cameras mounted on a cell phone are classified into two types; an inner-camera and an outer-camera, based on the position in which these cameras are mounted and their functions. The outer-camera mounted on a cell phone is a camera of the type which is mounted on the rear side of a monitor, that is, the back side of the cell phone. The outer-camera is suitably used, for example, to photograph a subject while confirming the subject's image on the monitor. On the other hand, the inner-camera mounted on the cell phone is a camera of the type which is mounted on the same side as the monitor. The inner-camera is suitably used, for example, when a photographer captures an image of himself while observing an image on the monitor and when a calling party and a called party capture their own images and talk with each other over the phones face to face with each other with the phones serving as videophones.

A cell phone which includes a light source dedicated to a camera is known. A cell phone of the above mentioned type includes, for example, an LED (Light Emitting Diode) as a light source dedicated to an outer-camera. This type of cell phone, when taking an image, receives an operation executed by a user of using the light source, and emits light from the LED. As a result, it may become possible for the cell phone to increase the illuminance of a subject and it may be possible to take an image even in dark locations.

In addition, a cell phone of the type having a function of adjusting the quantity of incident light when taking an image is also known. A cell phone of the type which is disclosed, for example, in Japanese Laid-open Patent Publication No. 2005-252582 includes an LCD (Liquid Crystal Display) which operates as a means for illumination adjustment. The above mentioned cell phone receives an operation of adjusting the quantity of incident light which is executed by a user when taking an image, and changes the quantity of light transmitting through the LCD. The above mentioned cell phone may make it possible to capture an image in the dark by including an LCD having a higher transmittance. However, in order to increase the illumination, it may be better to install a dedicated light source.

### SUMMARY

According to an aspect of the embodiment, a portable terminal having a camera includes; a display unit which displays an image captured by the camera, the display unit located so that an exposure range illuminated with display light of the display unit and at least a part of a capturing range captured by the camera overlap each other, a display image generating unit which generates a display image having a luminance which is higher than the luminance of the captured image, while maintaining the form of a subject in the captured image, and a display control unit which controls the display of the display image in the display unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a functional block diagram illustrating a configuration of a portable terminal according to a first embodiment;

FIG. 2 is a diagram illustrating a cell phone according to a second embodiment;

FIG. 3 is a functional block diagram illustrating a configuration of a cell phone according to the second embodiment;

FIG. 4 is a diagram illustrating an example of a luminance criteria data table which is stored in a luminance criteria data storage unit;

FIG. 5 is a diagram illustrating an example of a light setting screen which is displayed using a terminal software control unit;

FIG. 6 is a diagram illustrating an example of an image which is not reduced;

FIG. 7 is a diagram illustrating an example of a white composition process executed using a white composition unit;

FIG. 8 is a diagram illustrating a flowchart of procedures of a process executed using a cell phone according to the second embodiment;

FIG. 9A is a diagram illustrating an example of an image which is displayed using a display unit;

FIG. 9B is a diagram illustrating an example of an image which is displayed using the display unit;

FIG. 9C is a diagram illustrating an example of an image which is displayed using the display unit;

FIG. 9D is a diagram illustrating an example of an image which is displayed using the display unit;

FIG. 10 is a diagram illustrating a flowchart of procedures of an image reduction process executed using a cell phone according to the second embodiment when “Auto” has been selected as light setting;

FIG. 11 is a diagram illustrating a flowchart of procedures of a white composition process executed using a cell phone according to the second embodiment;

FIG. 12 is a diagram illustrating an example of an image on which a white composition process is not yet executed;

FIG. 13 is a diagram illustrating an example of a set of cell phones according to a third embodiment;

FIG. 14 is a functional block diagram illustrating a configuration of a set of cell phones according to the third embodiment;

FIG. 15 is a diagram illustrating a flowchart of procedures of processes executed using cell phones according to the third embodiment; and

FIG. 16 is a functional block diagram illustrating a configuration of a computer for executing a luminance adjustment program.

### DESCRIPTION OF EMBODIMENTS

Preferred embodiments of a portable terminal and a luminance adjustment program disclosed in the present application will be described in detail with reference to the accompanying drawings. The present invention is not limited to the embodiments which will be described later.

### First Embodiment

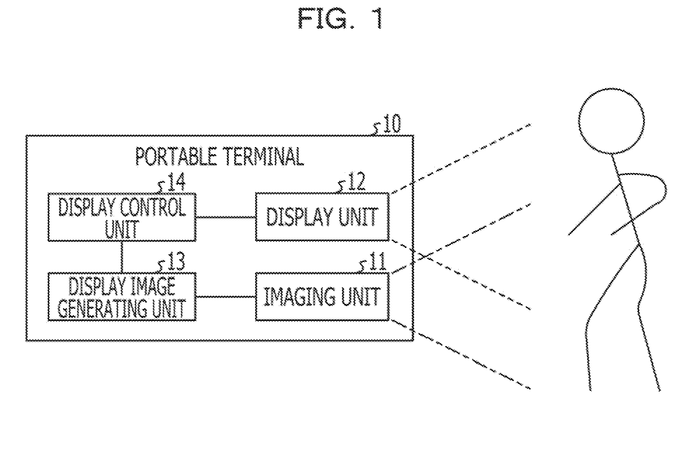

An example of a configuration of a portable terminal according to an embodiment 1 will be described with reference to FIG. 1. FIG. 1 is a functional block diagram illustrating an example of a configuration of a portable terminal according to the first embodiment. As illustrated in FIG. 1, a portable terminal 10 according to the first embodiment includes an imaging unit 11, a display unit 12, a display image generating unit 13, and a display control unit 14.

The imaging unit 11 captures an image of a subject. The display unit includes a display area for displaying an image which has been captured using the imaging unit 11, and is located so that an exposure range that is illuminated with display light radiated from the display area and at least part of an imaging range within which the imaging unit 11 captures the subject, overlap each other. The display image generating unit 13 generates a display image of a luminance which is higher than that of the image which has been captured using the imaging unit 11, while maintaining the form of the subject in the captured image. The display control unit 14 controls the display of the image which has been generated using the display image generating unit 13 in the display area included in the display unit 12.

In the portable terminal 10 according to the first embodiment, the display light of the display unit 12 is radiated to the subject that the imaging unit 11 will capture. In displaying the image which has been captured using the imaging unit 11, the display image, which is increased in luminance, is displayed in a status in which the form of the subject is maintained. The illuminance of the subject is increased by increasing the luminance of the image which is displayed on the display unit 12. Therefore, with the use of the portable terminal 10 according to the first embodiment, it may become possible to increase the illuminance of the subject without providing a dedicated light source.

### Second Embodiment

Next, an example of a portable terminal according to the second embodiment will be described. In the following, a cell phone will be described as an example of the portable terminal. The present invention is not limited by the embodiment which will be described below.

[Cell Phone According to Second Embodiment]

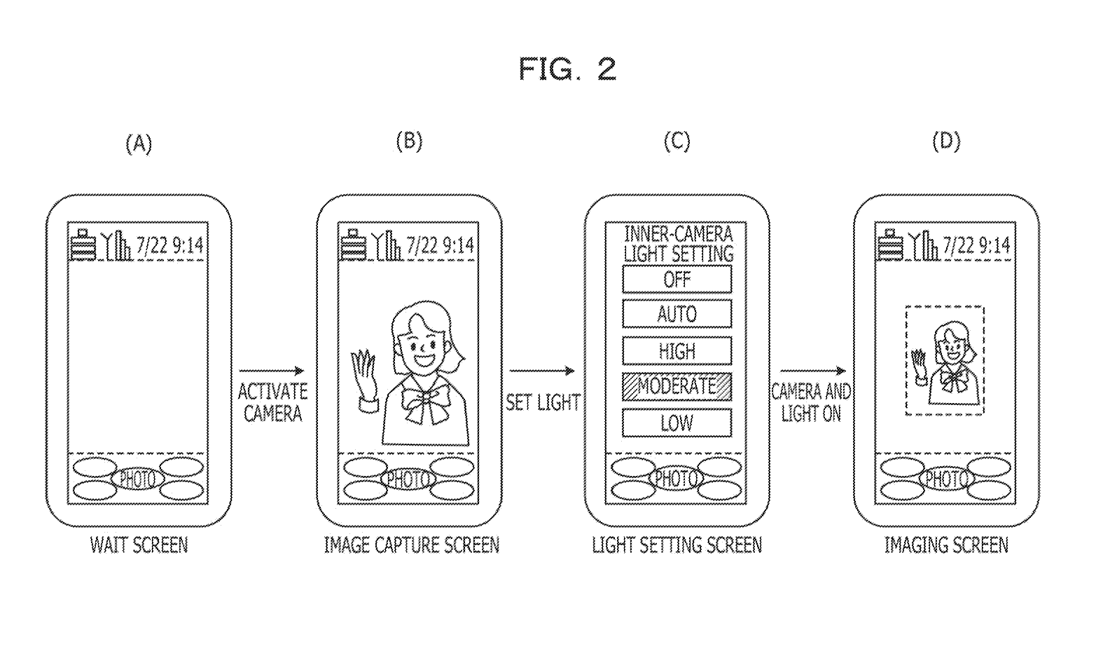

An example of a cell phone according to the second embodiment will be described with reference to FIG. 2. FIG. 2 is a diagram illustrating examples of luminance adjustment executed using the cell phone according to the second embodiment. The cell phone according to the second embodiment is constructed as a cell phone with an inner-camera and provides a user with a level of luminance which is desirable for the user to capture the image of a subject. The inner-camera is a camera which is mounted on the same side as a monitor. As described above, the inner-camera is mounted on the same side as the monitor, so that the exposure range that is illuminated with display light radiated from the monitor and at least a part of an imaging range within which the inner-camera captures the subject, overlap each other.

FIG. 2 (A) illustrates an example of a monitor screen in a waiting status of a cell phone. As illustrated in the example in FIG. 2 (A), the cell phone according to the second embodiment displays a wait screen when any specific function such as a radio communication function, a camera function, or the like is inactive.

A cell phone in which a user has selected an imaging function activates the camera and switches the screen from the wait screen to a screen that displays an image of a subject that the camera has captured on a monitor such as an LCD, or the like. FIG. 2 (B) is a diagram illustrating an example of a cell phone monitor screen obtained when the imaging function has been activated. As illustrated in FIG. 2 (B), the cell phone processes the image that the camera has captured and displays the captured image on the monitor, almost in real time.

In case the user decides that the level of the luminance of an image which is being captured using the camera is low, the cell phone receives a light setting operation executed by the user in order to increase the illuminance of the subject. FIG. 2 (C) illustrates an example of a monitor screen of the cell phone which is displayed when the screen has been switched to a light setting screen. As illustrated in FIG. 2 (C), the cell phone displays a selection menu allowing the user to set the light luminance level by selecting one of three levels of “Low”, “Medium” and “High” or by selecting “Auto”. In the explanation of the embodiment, a case in which the cell phone has received a user's selection to set the luminance to “Medium” will be described by way of example.

The cell phone which has received selection of the luminance from the user switches the screen from the light setting screen to an image capture screen. FIG. 2 (D) illustrates an example of a monitor screen of the cell phone which is displayed when an image is captured when the luminance is set to “Medium”. As illustrated in the example in FIG. 2 (D), the cell phone displays a subject image which is reduced to a size smaller than that of an LCD display screen. Then, the cell phone replaces an image in an area other than an area in which the reduced image is displayed on the monitor screen with a high-luminance image. In the examples illustrated in the drawings, the cell phone whitens the area other than the area in which the reduced image is displayed on the monitor screen as a high-luminance image of a composite image.

When the luminance of the subject image that has been captured using the camera so as to be displayed on the monitor is insufficient, the cell phone reduces the area of the subject image to be displayed and to whiten the area of the monitor screen other than the area in which the subject image is displayed to form a composite image including a white image. As a result, it may become possible for the cell phone to increase the illuminance of the subject by utilizing the white image area as a light source, thereby allowing the cell phone to increase the illuminance of the subject without providing the camera with a dedicated light source.

[Configuration of Cell Phone According to Second Embodiment]

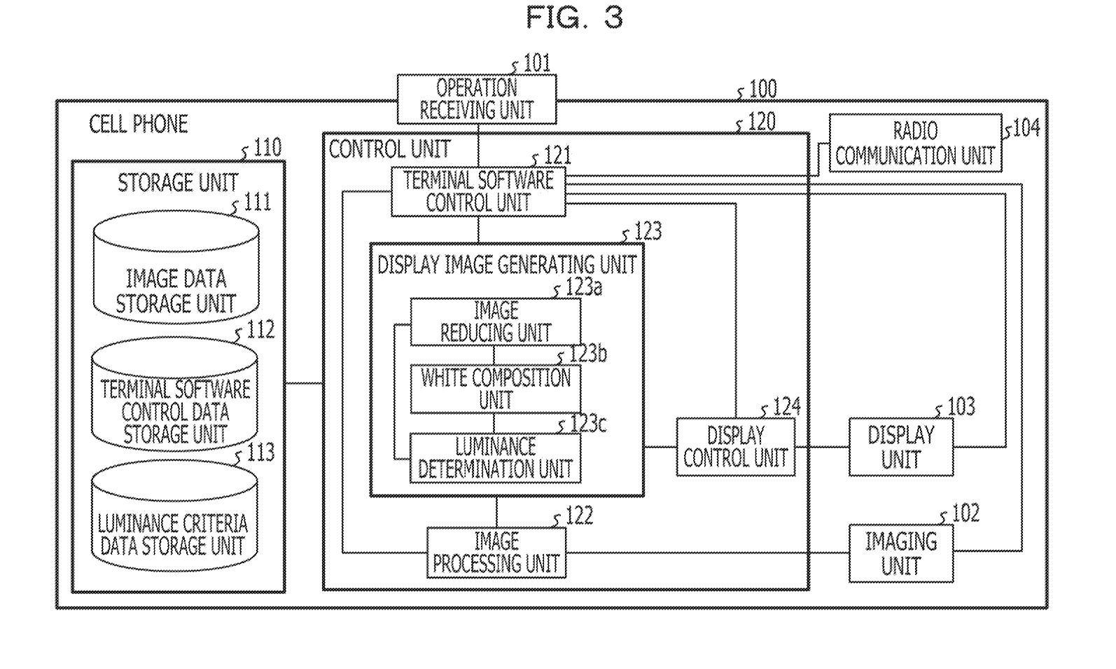

Next, an example of a configuration of the cell phone 100 according to the second embodiment will be described with reference to FIG. 3. FIG. 3 is a functional block diagram illustrating an example of a configuration of a cell phone 100 according to the second embodiment. As illustrated in FIG. 3, the cell phone 100 includes an operation receiving unit 101, an imaging unit 102, a display unit 103, a radio communication unit 104, a storage unit 110 and a control unit 120.

The operation receiving unit 101 receives an arbitrary operation executed by the user on the cell phone 100. The operation receiving unit 101 notifies the terminal software control unit 121 of the operation which has been received from the user. Operations that the operating receiving unit 101 receives from the user are operations relating to all the functions that the cell phone has, such as a radio communication control function, camera activating and imaging functions, a light setting function, captured image processing and image data storing and reading functions, a monitor switching function, and the like. As examples of the operation receiving unit 101, a touch panel which is integrated with the display unit 103, operation buttons configured by including a plurality of keys such as a ten-key, a cross-key, and the like may be installed on the body of the cell phone 100.

The imaging unit 102 captures images of subjects such as persons and scenery. The imaging unit 102 directs light radiated from a subject through a lens to a light receiving surface of an imaging element to form an image thereon and to convert the contrast of light into electric signals. The imaging unit 102 transfers the electric signals to an image processing unit 122 and the transferred electric signals are converted into digital data using the image processing unit 122. As examples of the imaging unit 102, digital cameras utilizing a CCD (Charge Coupled Device) image sensor, a CMOS (Complementary Metal Oxide Semiconductor), and the like as imaging elements may be given. In the example of the second embodiment, an inner-camera is used as the imaging unit 102.

The display unit 103 functions as a monitor in the cell phone 100. The display unit 103 includes a display area and provides the user with information by displaying characters and images in the display area. When the imaging unit 102 is activated, the display unit 103 displays an image which has been captured using the imaging unit 102. As examples of the display unit 103, displays including an LCD (Liquid Crystal Display), an organic EL (Electro-Luminescence) display, and the like may be given. In the example of the embodiment illustrated in the drawing, the display unit 103 is located so that the exposure range which is illuminated with display light radiated from the display area, and at least a part of an imaging range within which the imaging unit 102 captures an image, overlap each other.

The radio communication unit 104 executes radio communication between the cell phone 100 and another cell phone or a base station. For example, the radio communication unit 104 handles voice and e-mail transmission and reception executed between the cell phone 100 and another cell phone.

The storage unit 110 stores data and programs which are used for various processes executed using the cell phone 100. The storage unit 110 includes an image data storage unit 111, a terminal software control data storage unit 112, and a luminance criteria data storage unit 113. As examples of the storage unit 110, semiconductor memories such as a flash memory, a ROM (Read Only Memory), a RAM (Random Access Memory), an SD memory, and the like may be given.

The image data storage unit 111 stores image data. The image data storage unit 11 saves such data, that is, the digital data that the image processing unit 122 has converted from the electric signals of the image which have been captured using the imaging unit 102.

The terminal software control data storage unit 112 stores information which is used to control and manage various functions which are provided by the cell phone 100. For example, the terminal software control data storage unit 112 stores information that is used in the functions included in the cell phone, such as a radio communication control function, camera activation and imaging functions, a light setting function, captured image processing and image data saving and reading functions, a monitor switching function, and the like. When an operation selected by the user is to be executed using a terminal software control unit 121, the terminal software control data storage unit 112 provides the terminal software control unit 121 with data and programs which are used for execution of the operation.

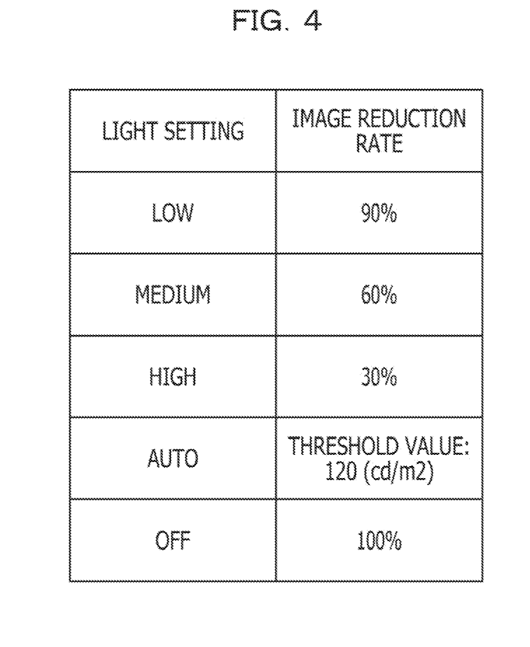

The luminance criteria data storage unit 113 stores information used to determine an image reduction process that is executed using a display image generating unit 123. FIG. 4 is a diagram illustrating an example of a luminance criteria data table stored in the luminance criteria data storage unit 113. As illustrated in FIG. 4, in the luminance criteria data table, information on the “Light Setting” and the corresponding “Image Reduction Rate” is stored. In the luminance criteria data table, the item of “Light Setting” indicates the light setting level of “Low”, “Medium” or “High” that the luminance is set at, or that the luminance is automatically set. In the item of “Light Setting”, “Off” means that no light setting has been executed. In the luminance criteria data table, values of the image reduction rate corresponding to the respective “Light Setting” levels are stored in the columns of the “Image Reduction Rate”. For example, in the luminance criteria data table, the light setting of “Low” indicates that an image that has been transferred to the display image generating unit 123 is reduced to “90%” of the original size using the display image generating unit 123. The image reduction rate is not limited to the values illustrated in FIG. 4 and may be set to arbitrary values by the user.

In the luminance criteria data table, when the user sets the luminance to adjust automatically, a threshold value that serves as a luminance criterion is stored in the column of the item of “Image Reduction Rate”, which corresponds to the information indicating that “Auto” is set as the “Light Setting”. For example, the luminance criteria data table indicates that when the threshold value is 120 (cd/m²), the threshold value is used as a criterion to determine if the luminance of the image concerned is higher than 120 (cd/m²). The threshold value is not limited to the value illustrated in FIG. 4, and may be set to an arbitrary value by the user.

The control unit 120 controls functions which are processed using the cell phone 100. For example, the control unit 120 controls the functions that the cell phone 100 includes such as a radio communication control function, camera activating and imaging functions, a light setting function, captured image processing and image data saving and reading functions, a monitor switching function, and the like. The control unit 120 includes the terminal software control unit 121, the image processing unit 122, the display image generating unit 123, and a display control unit 124.

The terminal software control unit 121 controls and manages various functions that are provided by the cell phone 100. The terminal software control unit 121 controls a corresponding process on the basis of an operation that the operation receiving unit 101 has received from the user. Specifically, the terminal software control unit 121 controls the functions that the cell phone 100 includes such as a radio communication control function, camera activating and imaging functions, a light setting function, captured image processing and image data saving and reading functions, a monitor switching function, and the like.

The terminal software control unit 121 also controls radio communication. For example, the terminal software control unit 121 controls radio communication executed between the cell phone 100 and another cell phone or a base station. For example, the terminal software control unit 121 controls voice and e-mail transmission and reception executed using the cell phone 100.

The terminal software control unit 121 further controls the operation of the imaging unit 102. For example, when the operation receiving unit 101 has received an operation from the user of activating the imaging unit 102, the terminal software control unit 121 controls the activation of the imaging unit 102 and displays the image which has been captured using the imaging unit 102 on the screen of the display unit 103.

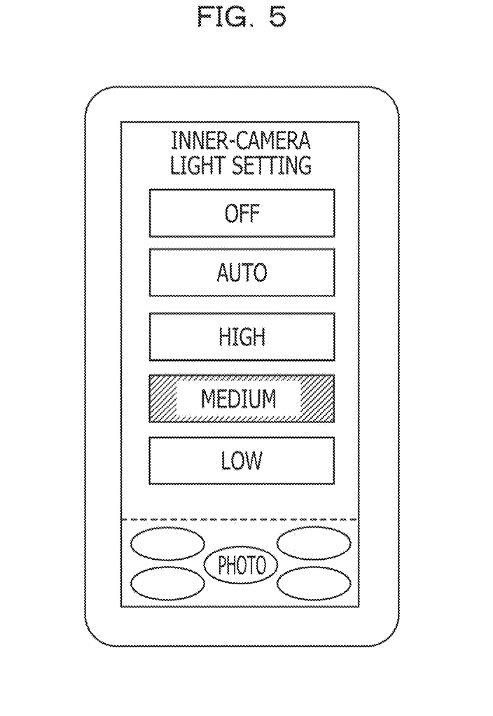

In the example of the second embodiment, the terminal software control unit controls the switching of the monitor in light setting. FIG. 5 is a diagram illustrating an example of a light setting screen which is displayed using the terminal software control unit 121. The terminal software control unit 121 controls switching the screen of the display unit 103 to the light setting screen illustrated in FIG. 5. As illustrated in FIG. 5, for example, the terminal software control unit 121 controls the monitor to display “Off”, “Auto”, “High”, “Medium” and “Low”, which mean the luminance settings. “Off” means that no light setting is executed. “Auto” means that light setting is executed automatically. For example, the cell phone 100 calculates the luminance of an image and sets the light setting so that the calculated luminance of the image becomes higher than a predetermined threshold value on the basis of the luminance criteria data table. “High” means executing the light setting that has the highest luminance. For example, the cell phone 100 generates an image of high luminance by reducing the image to 30% of the original size on the basis of the luminance criteria data table, and by whitening a blank area which is made on the display screen to form a composite image to be displayed as a display image. “Medium” means executing the light setting that is the second highest in luminance next to the “High” light setting. For example, the cell phone 100 generates an image of high luminance by reducing the image to 60% of the original size based on the luminance criteria data table, and by whitening the blank area which is made in the display screen to form a composite image. “Low” means the light setting that has the lowest luminance is executed. For example, the cell phone 100 generates an image of high luminance by reducing the image to 90% of the original size based on the luminance criteria data table, and by whitening the blank area which is made on the display screen to form a composite image to be displayed as a display image. The terminal software control unit 121 receives the selection of a given light setting from the user via the operation receiving unit 101. Then, the terminal software control unit 121 sends the display image generating unit 123 a notification that a light setting from the user has been received.

The terminal software control unit 121 saves a captured image in a storage unit and reads the image out of the storage unit. When the operation receiving unit 101 has received from the user an operation of saving the captured image, the terminal software control unit 121 controls the image processing unit 122 and saves the captured image to the image data storage unit 111. When the operation receiving unit 101 has received an operation from the user of reading previously stored image data, the terminal software control unit 121 controls the reading of the applicable data from the image data storage unit 111 and transfers the read data to the image processing unit 122. Then, the image processing unit 122 edits the transferred data to a size suitable to be displayed on the display unit 103, and makes the display unit 103 display the data via the display control unit 124.

The terminal software control unit 121 controls monitor switching. For example, when the operation receiving unit 101 has received a given operation from the user, the terminal software control unit 121 controls switching the screen on the display unit 103 to a screen corresponding to the received operation. Specifically, the terminal software control unit 121 controls switching the screen to a screen suited for each of the various operations corresponding to the given operation that the operation receiving unit 101 has received from the user. For example, the terminal software control unit 121 executes screen switching for incoming and outgoing calls, and screen switching for e-mail transmission and reception.

The image processing unit 122 executes a digitizing process on the image data. The image data digitizing process that is executed using the image processing unit 122 is classified into two types. One is a digitizing process that is executed when the imaging unit 102 is being activated, and another is a digitizing process that is executed when the imaging unit 102 is not activated.

For example, when the imaging unit 102 has been activated, the image processing unit 122 processes an image which has been captured using the imaging unit 102. The image processing unit 122 converts the image of the subject into digital data based on the electric signals obtained from the image of the subject that the imaging unit 102 has captured. The image processing unit 122 converts the image that the imaging unit 102 has captured to an image size suitable to be displayed on the display unit 103. The size suitable to be displayed on the display unit 103 is defined as an LCD display size. The image processing unit 122 executes image processing for correcting the tone and the gradation of the image. The image processing unit 122 transfers the digitized image data of the subject to the display image generating unit 123. The image data which has been transferred to the display image generating unit 123 is displayed on the display unit via the display control unit 124. As a result, it may be possible for the display unit 103 to display almost in real time the image that the imaging unit 102 has captured.

When an operation of saving the image has been received from the user, the image processing unit 122 saves the edited image data in the image data storage unit 111. The image processing unit 122, which has determined that the operation receiving unit 101 has received the operation of saving the image, cuts off information transfer from the imaging unit 102. As a result, the image being saved is displayed on the display unit 103. When the imaging unit 102 is not activated, the image processing unit 122 reads the saved image data which has been selected by the user. When the terminal software control unit 121 has determined that the operation receiving unit 101 has received from the user an operation of reading the saved image, the image processing unit 122 transfers the image data that has been read from the image data storage unit 111, using the terminal software control unit 121 to the display image generating unit 123. The data that has been transferred to the display image generating unit 123 is displayed on the display unit 103 via the display control unit 124.

When a notification has been sent from the terminal software control unit 121 that a light setting has been received, the display image generating unit 123 generates a display image of a luminance which is higher than that of the captured image, while maintaining the form of the subject. Specifically, the display image generating unit 123 generates the display image by reducing the image that has been captured using the imaging unit 102 to a size which is smaller than the LCD display size, and by drawing a white image in a display area (that is, a blank space) other than the area in which the reduced image is displayed to form a composite image. The display image generating unit 123 determines if the luminance of the image, which has been captured using the imaging unit 102, is higher than a predetermined threshold value. When it has been determined that the luminance is not higher than the predetermined threshold value, the display image generating unit 123 generates a display image by further reducing the image which has been captured using the imaging unit 102, and by drawing a white image in the area other than the area in which the reduced image is displayed to form a composite image until the luminance becomes higher than the predetermined threshold value. The display image generating unit 123 transfers the image data which has been transferred from the image processing unit 122 to the display control unit 124. The display image generating unit 123 includes an image reduction unit 123a, a white composition unit 123b, and a luminance determination unit 123c.

In the case that a notification is not received from the terminal software control unit 121 that a light setting has been selected, the image reduction unit 123a transfers the image data which has been transferred from the image processing unit 122 to the display control unit 124. On the other hand, when the notification has been received from the terminal software control unit 121 that a light setting is selected, the image reduction unit 123a reduces the image data that has been transferred from the image processing unit 122 to a predetermined size, based on the luminance criteria data table.

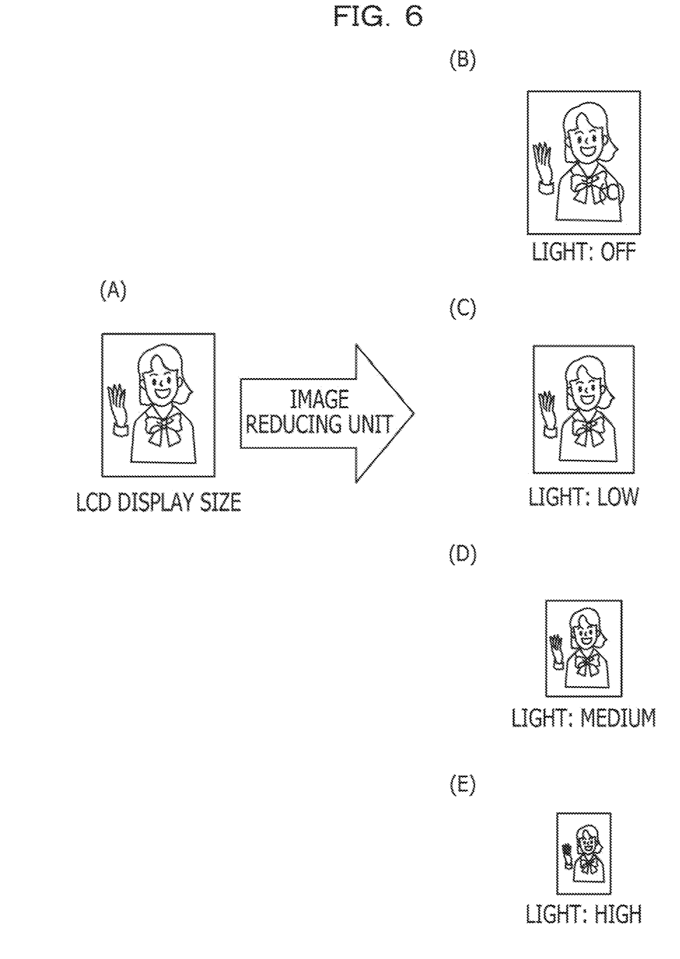

FIG. 6 is a diagram illustrating example of an image which is reduced using the image reduction unit 123a. The image reduction unit 123a receives the captured image which has been converted to an LCD-display-sized image using the image processing unit 122 as illustrated in FIG. 6 (A). FIG. 6 (B) illustrates an example of the image obtained when “Off” has been selected as the light setting. When the “Off” light setting has been selected as illustrated in FIG. 6 (B), the image reduction unit 123a maintains the LCD-display-sized image as it is, that is, at 100% size, based on the luminance criteria data table. FIG. 6 (C) illustrates an example of the image obtained when the “Low” light setting has been selected. When the “Low” light setting has been selected as illustrated in FIG. 6 (C), the image reduction unit 123a reduces the LCD-display-sized image to, for example, 90% of the original size, based on the luminance criteria data table. FIG. 6 (D) illustrates an example of the image obtained when the “Medium” light setting has been selected. As illustrated in FIG. 6 (D), when the “Medium” light setting has been selected, the image reduction unit 123a reduces the LCD-display-sized image to, for example, 60% of the original size based on the luminance criteria data table. FIG. 6 (E) illustrates an example of the image obtained when the “High” light setting has been selected. As illustrated in FIG. 6 (E), when the “High” light setting has been selected, the image reduction unit 123a reduces the LCD-display-sized image to, for example, 30% of the original size based on the luminance criteria data table. The image reduction unit 123a transfers the reduced image data to the white composition unit 123b.

The image reduction unit 123a reduces the image on the basis of light setting instruction information which has been transferred from the luminance determination unit 123c. The operation of the luminance determination unit 123c will be described later.

The white composition unit 123b forms a composite image of a higher luminance based on the image which has been transferred from the image reduction unit 123a. Specifically, the white composition unit 123b determines whether the image of the subject which has been reduced using the image reduction unit 123a is drawn, or whether a white image is drawn in order to increase the luminance in units of pixels to be displayed on the display unit 103.

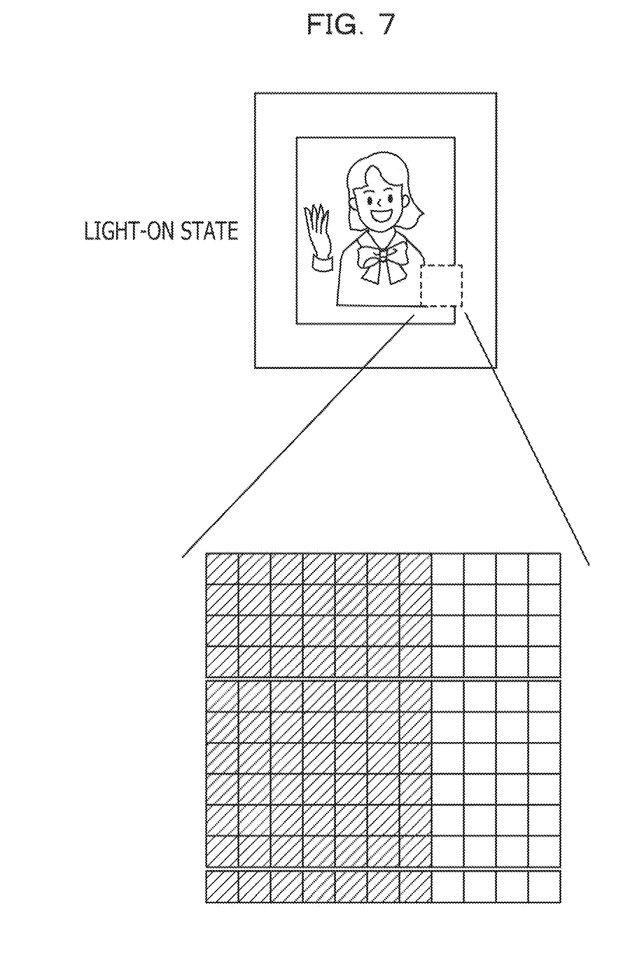

FIG. 7 is a diagram illustrating an example of white composite processing which is executed using the white composition unit 123b. FIG. 7 illustrates an example of a process of forming a composite image of a higher luminance which is executed using the white composition unit 123b based on the captured image which has been reduced using the image reduction unit 123a. Specifically, in FIG. 7, part of the image is enlarged to indicate that pixels in the area draw either the captured image or a white image. The white composition unit 123b arranges the captured image which has been reduced using the image reduction unit 123a so that the image is positioned at the center of the LCD-display-sized area. The white composition unit 123b determines whether each pixel is a pixel used to display the captured image on the basis of the number of displays in the LCD-display-sized area. When the pixel concerned is a pixel which is used to display the captured image, the white composition unit 123b draws the corresponding captured image on the position that the pixel concerned indicates. On the other hand, when the pixel concerned is not a pixel which is used to display the captured image, the white composition unit 123b draws a white image on the position that the pixel concerned indicates.

The luminance determination unit 123c calculates the luminance of the image and determines whether the luminance is higher than a predetermined threshold value. When the operation receiving unit 101 has received information from the terminal software control unit 121 that automatic light setting has been selected, the luminance determination unit 123c makes a determination. In an automatic light setting mode, the luminance determination unit 123c receives the captured image which has been drawn as a composite image using the white composition unit 123b and calculates the luminance of the received image. The luminance determination unit 123c reads the luminance criteria data table stored in the luminance criteria data storage unit 113 and determines whether the calculated luminance of the image is higher than the predetermined threshold value. When it has been determined that the calculated luminance of the image is not higher than the predetermined threshold value, the luminance determination unit 123c transfers instruction information to set the light for the image reduction unit 123a in order to increase the luminance of the image. The luminance determination unit 123c calculates the ratio of the white image which is displayed in the display area to the reduced image to calculate the “Image Reduction Rate” and determines the “Light Setting” level based on the calculated “Image Reduction Rate”. The luminance determination unit 123c causes the “Light Setting” to be increased one level higher than the determined “Light Setting”. When it has been determined that the luminance of the image is higher than the predetermined threshold value, the luminance determination unit 123c transfers the image data to the display control unit 124.

The display control unit 124 controls an image to be displayed on the display unit 103. The display control unit 124 receives the image which has been transferred from the image processing unit 122 via the display image generating unit 123 and makes the display unit 103 display the received image. The image that the display control unit 124 receives includes the image which has been edited using the display image generating unit 123 and the image stored in the image data storage unit 111.

[Process that Cell Phone Executes According to the Second Embodiment]

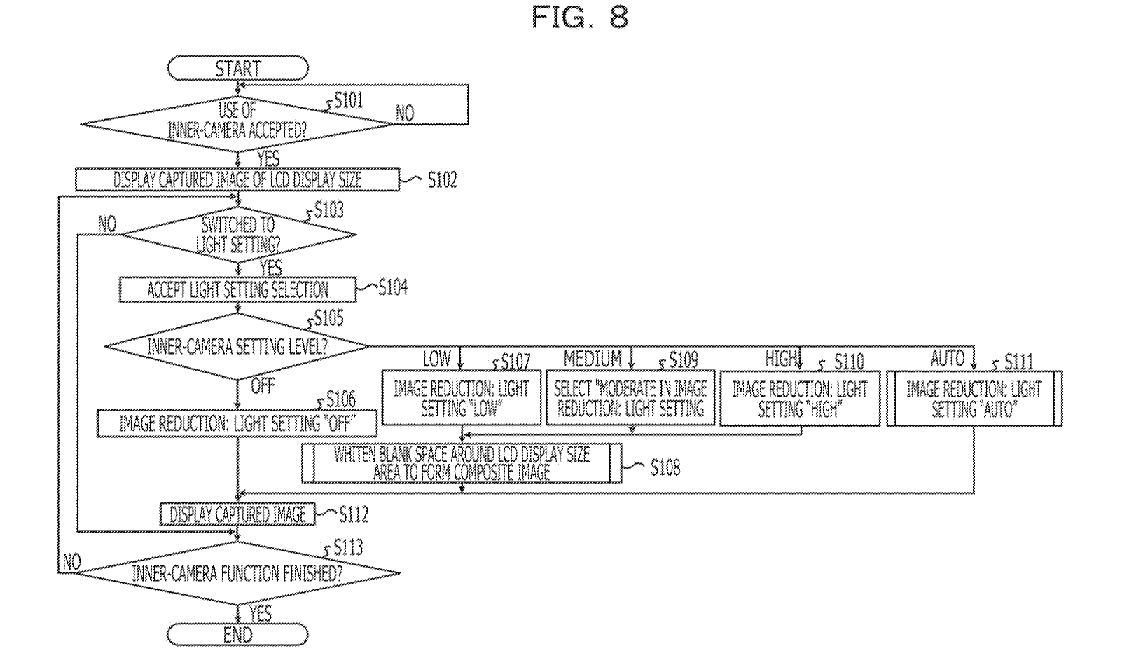

The flow of a process which is executed using the cell phone 100 according to the second embodiment will be described. FIG. 8 is a flowchart illustrating the flow of the process which is executed using the cell phone 100 according to the second embodiment.

As illustrated in FIG. 8, in the cell phone 100, the terminal software control unit 121 determines whether the operation receiving unit 101 has received a command to use the inner-camera (step S101). When it has been determined that the operation receiving unit 101 has received a command to use the inner-camera (step S101, Yes), the terminal software control unit 121 activates the imaging unit 102 and displays the LCD-display-sized captured image on the display unit 103 (step S102). The terminal software control unit 121 determines whether the operation receiving unit 101 has received a light setting from the user (step S103).

When it has been determined that the operation receiving unit 101 has not received a light setting (step S103, No), the terminal software control unit 121 maintains the status in which the LCD-display-sized captured image is displayed. When it has been determined that the operation receiving unit 101 has received a light setting (step S103, Yes), the terminal software control unit 121 displays the light setting screen on the display 103 to receive a light setting selection from the user (step S104). The terminal software control unit 121 transfers information of the light setting which has been selected by the user to the display image generating unit 123. The display image generating unit 123 determines which light setting has been transferred from the terminal software control unit 121 (step S105).

When “Off” has been selected as the light setting (step S105, Off), the display image generating unit 123 maintains the status in which the LCD-display-sized image is displayed (step S106). When the “Low” light setting has been selected (step S105, Low), the display image generating unit 123 reduces the image based on the luminance criteria data table (step S107). The display image generating unit 123 whitens the area which is made due to the image size reduction to form a composite image to be displayed as a display image (step S108). When the “Medium” light setting has been selected (step S105, Medium), the display image generating unit 123 reduces the image based on the luminance criteria data table (step S109). The display image generating unit 123 whitens the area which is made due to the image size reduction to form a composite image (step S108). When the “High” light setting has been selected (step 105, High), the display image generating unit 123 reduces the image based on the luminance criteria data table (step S110). The display image generating unit 123 whitens the area which is made due to the image size reduction to form a composite image to be displayed as a display image (step S108). When the “Auto” light setting has been selected (step S105, Auto), the display image generating unit 123 automatically reduces the image until the luminance becomes higher than a predetermined threshold value (step S111).

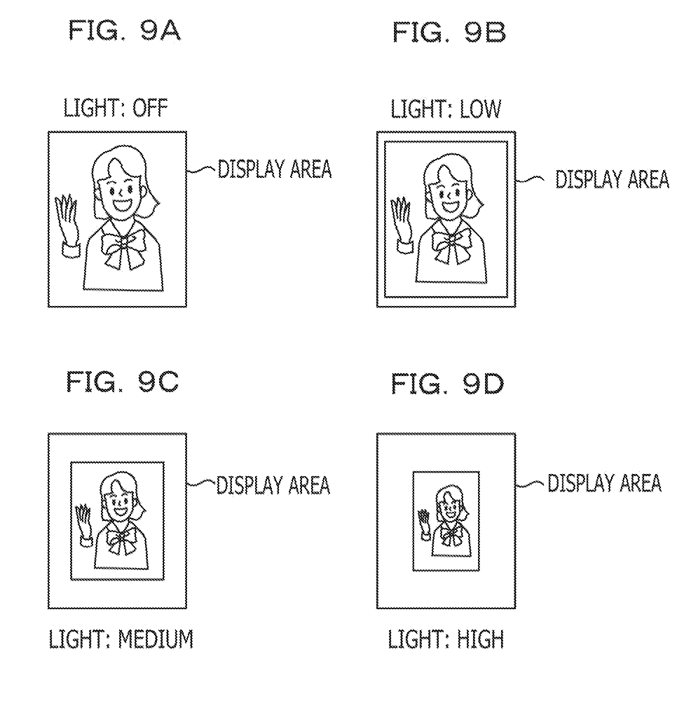

After execution of the processes as described above (steps S106 to S111), the display image generating unit 123 transfers the image to the display control unit 124 to display the image on the display unit 103 (step S112). Examples of images which are displayed as a result of execution of the above mentioned processes will be described with reference to FIG. 9. FIG. 9 is diagram illustrating example of the images which is displayed on the display unit 103. FIG. 9A illustrates an example of the image which is displayed when the “Off” light setting has been selected. When the “Off” light setting has been selected, the display image generating unit 123 generates an image which has the same size as the display image. FIG. 9B illustrates an example of the image which is displayed when the “Low” light setting has been selected. When the “Low” light setting has been selected, the display image generating unit 123 reduces the image based on the luminance criteria data table. In the example illustrated in the drawing, when the “Low” light setting has been selected, the display image generating unit 123 reduces the image to 90% of the original size and whitens the blank space that is made due to the image size reduction to form a composite image. Selecting the “Low” light setting may make it possible to provide a blank space as a white light source corresponding to 10% of the display screen. FIG. 9C illustrates an example of the image that is displayed when the “Medium” light setting has been selected. When the “Medium” light setting has been selected, the display image generating unit 123 reduces the image based on the luminance criteria data table. In the example illustrated in the drawing, when the “Medium” light setting has been selected, the display image generating unit 123 reduces the image to 60% of the original size and whitens the blank space that is made due to the image size reduction to form a composite image. Selection of “the Medium” light setting may make it possible to provide a space corresponding to 40% of the display screen as a white light source. FIG. 9E illustrates an example of the image which is displayed when the “High” light setting has been selected. When the “High” light setting has been selected, the display image generating unit 123 reduces the image based on the luminance criteria data table. In the example illustrated in the drawing, when the “High” light setting has been selected, the display image generating unit 123 reduces the image to 30% of the original size and whitens the blank space that is made due to the image size reduction to form a composite image. Selecting the “High” light setting may make it possible to provide a blank space corresponding to 70% of the display screen as a white light source. The light setting function may make it possible to display an image of a higher luminance in ascending order of “Off”, “Low”, “Medium” and “High” to provide the light source accordingly. An image which is displayed when “Auto” has been selected in the item of light setting will be described later.

The terminal software control unit 121 determines whether an operation of terminating a camera (imaging) function has been received from the user (step S113). When it has been determined that the operation of terminating the camera function has been received (step S113, Yes), the terminal software control unit 121 terminates the execution of the camera function. On the other hand, when it has been determined that the operation of terminating the camera function has not been received (step S113, No), the terminal software control unit 121 determines whether a light setting has been received (step S103) and repeats the above mentioned operations until the camera function is terminated.

[Image Reduction Process Executed in Auto Mode Using a Cell Phone]

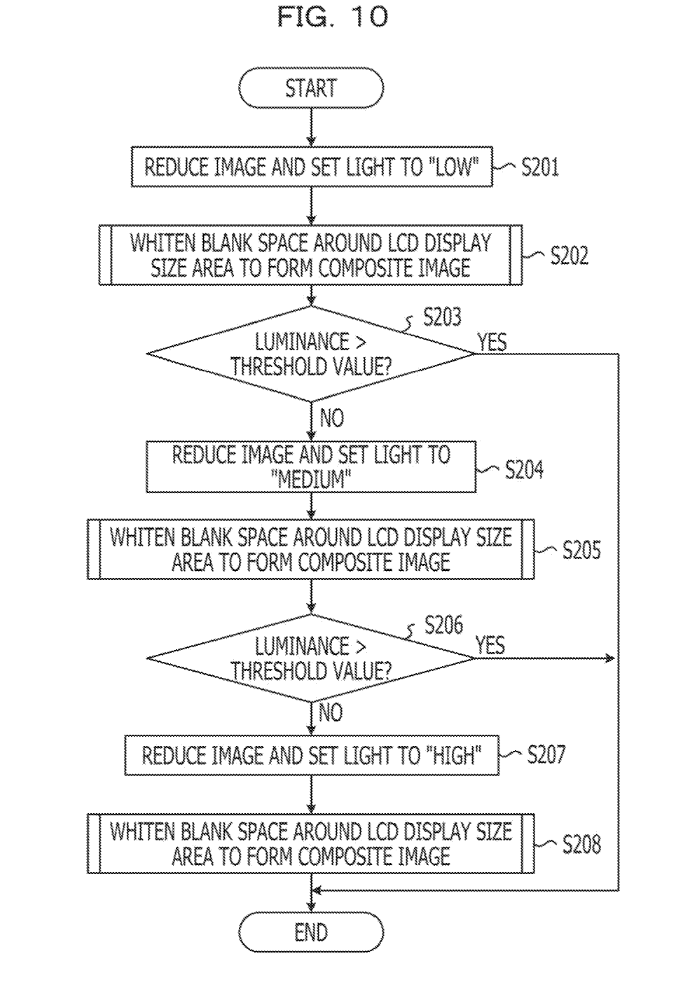

The flow of an image reduction process executed when “Auto” has been selected as the light setting using the cell phone 100 according to the second embodiment will be described. FIG. 10 is a flowchart illustrating the flow of an image reduction process that is executed in “Auto” mode using the above mentioned cell phone 100. The process which will be described below corresponds to the process at step S111 in FIG. 8.

As illustrated in FIG. 10, in the cell phone 100, when it has been determined that the operation receiving unit 101 has received the automatic light setting, the terminal software control unit 121 controls the display image generating unit 123 to execute an image reduction process. In the display image generating unit 123, the image reduction unit 123a reduces an image to a size corresponding to the “Low” light setting (step S201), and transfers the reduced image information to the white composition unit 123b. The white composition unit 123b whitens a blank space that is made in the area for displaying the LCD-display-sized image on the basis of the image information which has been transferred from the image reduction unit 123a to form a composite image (step S202).

In the cell phone 100, the luminance determination unit 123c determines whether the luminance of the composite image which has been formed using the white composition unit 123b has become higher than a predetermined threshold value (step S203). When the luminance determination unit 123c has determined that the luminance of the image has become higher than the predetermined threshold value (step S203, Yes), the cell phone 100 terminates the execution of the automatic light setting. As a result, the screen illustrated in FIG. 9B is displayed on the display unit 103.

In the cell phone 100, when it has been determined that the luminance of the image is not higher than the predetermined threshold value (step S203, No), the luminance determination unit 123c sends the image reduction unit 123a a notification that the luminance of the image is not higher than the predetermined threshold value and simultaneously transfers the applicable image to the image reduction unit 123a. Then, the image reduction unit 123a reduces the image to the size corresponding to the “Medium” light setting (step S204) and transfers the reduced image to the white composition unit 123b. The white composition unit 123b whitens the blank space that is made in the area for displaying the LCD-display-sized image based on the image information which has been transferred from the image reduction unit 123a to form a composite image (step S205).

In the cell phone 100, the luminance determination unit 123c determines whether the luminance of the composite image which has been formed using the white composition unit 123b has become higher than the predetermined threshold value (step S206). When the luminance determination unit 123c has determined that the luminance of the composite image has become higher than the predetermined threshold value (step S206, Yes), the cell phone 100 terminates the execution of the automatic light setting. As a result, the screen illustrated in FIG. 9C is displayed on the display unit 103.

In the cell phone 100, when it has been determined that the luminance of the image is not higher than the predetermined threshold value (step S206, No), the luminance determination unit 123c transfers information that the luminance of the image is not higher than the predetermined threshold value to the image reduction unit 123a. Then, the image reduction unit 123a reduces the image to the size corresponding to the “High” light setting (step S207) and transfers the reduced image to the white composition unit 123b. The white composition unit 123b whitens the blank space that is made in the area for displaying the LCD-display-sized image based on the image information which has been transferred from the image reduction unit 123a to form a composite image (step S208). As a result, the screen illustrated in FIG. 9D is displayed on the display unit 103.

In the procedures of the image reduction process illustrated in FIG. 10, the order in which the processes at steps S201, S204 and S207 are executed may be replaced with one another. For example, in the cell phone 100, the image reduction unit 123a need not necessarily start the execution of a process from the process of determining whether the luminance of the image has become higher than the predetermined threshold value after reducing the image to the size corresponding to the “Low” light setting, and may determine whether the luminance of the image has become higher than the predetermined threshold value after reducing the image to the size corresponding to the “Medium” or “High” light setting.

[White Composition Process Executed Using a Cell Phone]

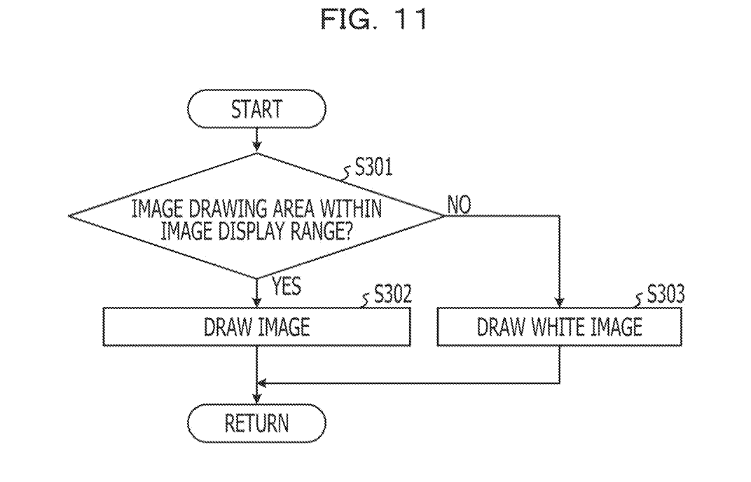

The flow of a white composition process executed using the cell phone 100 according to the second embodiment will be described. The process which will be explained in the example of the above mentioned embodiment corresponds to the process at step S108 in FIG. 8, and the processes at steps S202, S205, and S208 in FIG. 10. FIG. 11 is a flowchart illustrating the flow of the white composition process executed using the cell phone 100.

As illustrated in the example in FIG. 11, in the cell phone 100, the white composition unit 123b determines whether an image drawing area (an area in which an image is to be drawn) is within an image display range (step S301). When it has been determined that the area is within the image display range (step S301, Yes), the white composition unit 123b draws a captured image in the drawing area (step S302). On the other hand, when it has been determined that the drawing area is not within the image display range (step S301, No), the white composition unit 123b draws a white image in the drawing area (step S303).

[Effect of the Second Embodiment]

As described above, according to the second embodiment, in the cell phone 100, the imaging 102 unit captures an image of a subject. The display unit 103 has a display area in which the image that has been captured using the imaging unit 102 is displayed. The display unit 103 is located so that the exposure range which is illuminated with display light radiated from the display area of the display unit 103 and at least a part of the range within which the imaging unit captures the subject may overlap each other. As a result, the display light from the display unit 103 is radiated to the subject. The display image generating unit 123 generates a display image of a luminance which is higher than that of the captured image while maintaining the form of the subject in the image which has been captured using the imaging unit 102. The display control unit 124 controls the display unit 103 to display the image which has been generated using the display image generating unit 123 so as to have a luminance that is higher than that of the captured image. As a result, as the luminance of the image which is displayed on the display unit 103 is increased, the illuminance of the subject is increased accordingly. Therefore, use of the cell phone 100 according to the second embodiment may make it possible to increase the illuminance of the subject without the provision of a dedicated light source.

In the second embodiment, the display image generating unit 123 generates the display image by reducing the image which has been captured using the imaging unit 102 to the size conforming to the user's selection and whitening the area other than the area in which the reduced image is displayed to form a composite image. Therefore, according to the second embodiment, the luminance may be set in accordance with the user's selection.

In the second embodiment, the display image generating unit 123 determines whether the luminance of the image which has been captured using the imaging unit 102 is higher than the predetermined threshold value. When it has been determined that the luminance of the image is not higher than the predetermined threshold value, the display image generating unit 123 generates the display image by reducing the image that has been captured using the imaging unit 102, and by whitening the area other than the area in which the reduced image is displayed to form the composite image until the luminance of the image becomes higher than the predetermined threshold value. Therefore, according to the second embodiment, automatic adjustment of the luminance of the image may be possible.

In the second embodiment, the luminance of the image is increased by displaying the white image in the blank space. As an alternative, when the display unit includes a back light, the display control unit may control increasing the luminance of the image to be displayed on the display unit by increasing the current of the back light included in the display unit. As a result, it may become possible to increase the illuminance of the subject co-operatively.

In the above mentioned example of the embodiment, as the levels of the luminance to be adjusted, three levels of “Low”, “Medium”, and “High” are set. However, in the portable terminal disclosed in the present application, the luminance is not limited to the above mentioned levels. For example, the cell phone 100 may be configured to more finely adjust the luminance by preparing as many luminance levels as possible. In addition, adjustment of the luminance is not limited to stepwise adjustment, and the cell phone 100 may be configured to adjust the luminance linearly.

In the above mentioned embodiment, the example in which the white composition unit of the portable terminal forms the composite image by whitening the blank space has been described. However, in the portable terminal which is disclosed in the present application, the color is not limited to white. For example, as the color that the white composition unit uses to form the composite image, a color other than white may be used as long as the color is of the type which is suited to increase the illuminance of the subject.

In the above mentioned embodiment, the example in which the cell phone is used as the portable terminal has been described. However, the portable terminal which is disclosed in the present application is not limited to a cell phone. For example, the portable terminal may be a portable game machine, a notebook-sized personal computer, or the like as long as such two conditions are met that the portable terminal includes at least an imaging unit and a display unit, and that in the portable terminal, the display unit includes a display area in which an image that has been captured using the imaging unit is displayed and is located so that the exposure range which is illuminated with display light radiated from the display area and at least a part of an imaging range within which the imaging unit captures the subject overlap each other.

In the above mentioned embodiment, the example has been described in which the camera that is mounted on the portable terminal is the inner-camera. However, in the portable terminal which is disclosed in the present application, the camera is not limited to the inner-camera. For example, an outer-cameral may be similarly applied to the portable terminal. In the case where the portable terminal is configured to be applied to the outer-camera, the display unit is installed on the side of the outer-camera. The display unit may be similarly applied to the outer-camera as long as two conditions are met such that the display unit includes a display area in which an image that has been captured using the imaging unit is displayed and that the display unit is located so that the exposure range which is illuminated with display light radiated from the display area and at least a part of an imaging range within which the outer-camera captures a subject overlap each other.

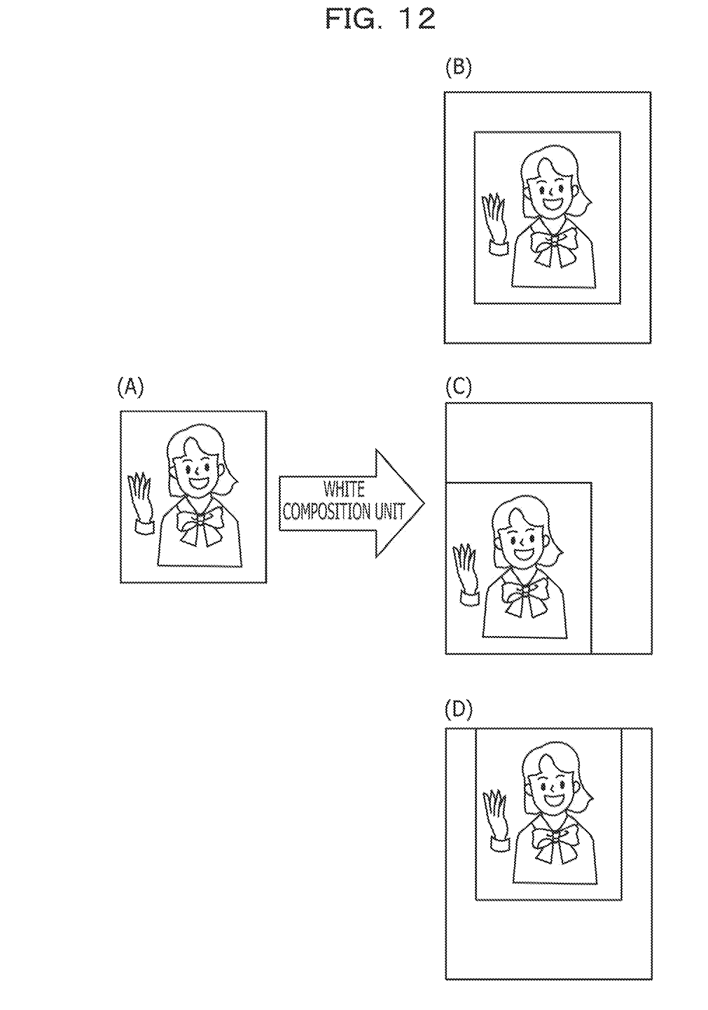

In the above mentioned embodiment, the example has been described in which the white composition unit 123b of the portable terminal positions the image which has been reduced using the image reduction unit 123a at the center of the display screen and whitens the blank space that is made around the image display area to form the composite image. The portable terminal which is disclosed in the present application is not limited to the above. Next, specific examples will be described with reference to FIG. 12. FIG. 12 (A) illustrates an example of an image which has been reduced using the image reduction unit 123a. (B), (C) and (D) of FIG. 12 are diagrams illustrating examples of composite images which are formed using the white composition unit 123. FIG. 12 (B) illustrates an example of an image which has been formed as a composite image using the white composition unit 123b which has been described in relation to the second embodiment. In the example in FIG. 12 (B), the white composition unit 123b positions the image which has been reduced using the image reduction unit 123a at the center of an area the size of which is suited to be displayed on the display unit 103, and whitens the blank space that is made, for example, around the image display area to form the composite image. In FIG. 12 (C), the white composition unit 123b positions the image which has been reduced using the image reduction unit 123a on the lower left end part of the area the size of which is suited to be displayed on the display unit 103 and whitens a blank space that is made, for example, on an upper right end part of the image display area to form the composite image. In FIG. 12 (D), the white composition unit 123b positions the image which has been reduced using the image reduction unit 123a on an upper central part of the area the size of which is suited to be displayed on the display unit 103 and whitens the blank space that is made, for example, on a lower half part of the image display area to form the composite image. Therefore, it may become possible for the white composition unit 123b to form the composite image by locating the image which has been reduced using the image reduction unit 123a at an arbitrary position of the LCD-display-sized area in the display unit.

In the above mentioned embodiment, in the white composition process executed using the white composition unit 123b included in the cell phone 100, whether the captured image is drawn and whether the white image is drawn has been determined per each display. However, the portable terminal disclosed in the present application is not limited to the above mentioned configuration. For example, the white composition unit 123b may draw the captured image that has been reduced on an arbitrary part in a display area, and may draw a white image in an area in which the captured and reduced image is not drawn after the captured and reduced image has been drawn.

In the above mentioned embodiment, the example has been described in which the image that is captured using the portable terminal is a static image. However, the portable terminal disclosed in the present application is not limited to a portable terminal of the above mentioned type. For example, an image that is captured using the portable terminal may be a moving image.

### Third Embodiment

In the explanation of the second embodiment, the imaging function which is executed using the inner-camera that is mounted on the cell phone has been described. A cell phone of the type having a videophone function is also available. In the explanation of the third embodiment, an example in which the luminance of an image which has been captured using the inner-camera is adjusted while talking using the videophone function of the cell phone will be described.

[Cell Phone According to the Third Embodiment]

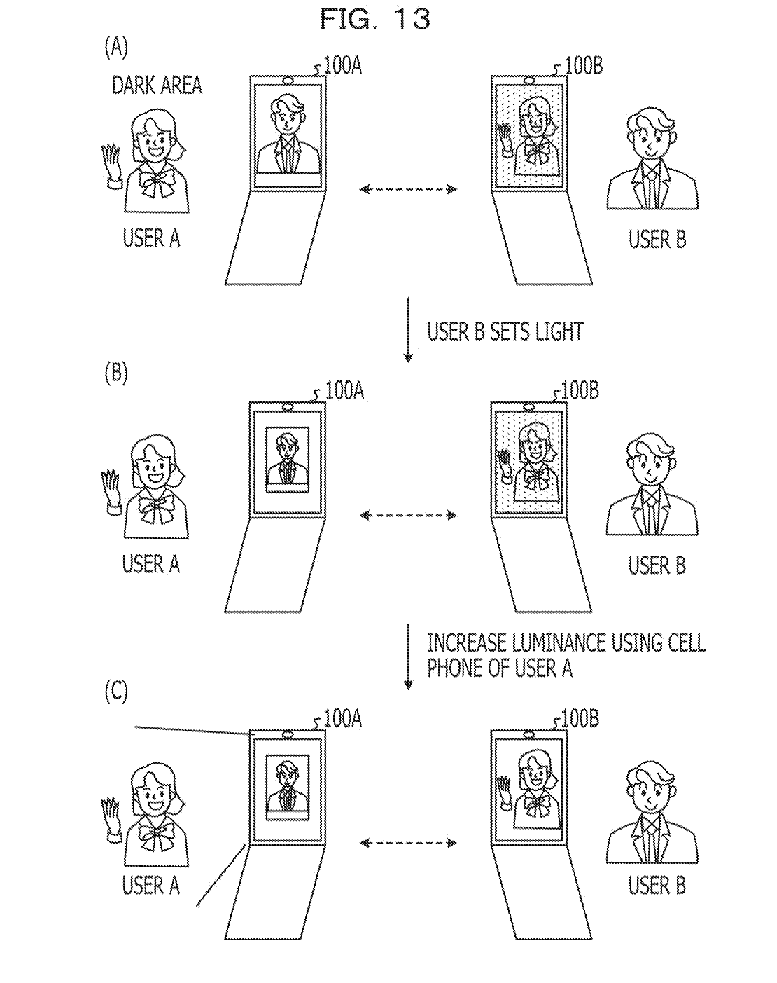

FIG. 13 illustrates diagrams of examples of a set of cell phones according to the third embodiment, in which FIG. 13 (A) illustrates an example in which a user A is talking with a user B over the cell phones 100 utilizing the videophone function. In the examples of the third embodiment, in order to discriminate the cell phones 100 that the users A and B use from each other, the cell phone that user A uses is designated as 100A and the cell phone that user B uses is designated as 100B. When user A talks with user B over the phones in the dark, the luminance of the image of user A that is displayed on the cell phone 100B of user B is reduced. Thus, the cell phone 100B receives a light setting selection from user B.

The cell phone 100B transmits an image of user B to the cell phone 100A via radio communication and simultaneously transfers instructions to the cell phone 100A to execute light setting. The cell phone 100A which has received the instruction to execute a light setting reduces the image of the user B which has been transmitted and whitens the blank space that is made around the reduced image to form a composite image. As a result, the cell phone 100A generates an image of higher luminance. As the luminance of the image is increased, the illuminance of user A is increased accordingly (FIG. 13 (B)). The camera mounted on the cell phone 100A captures user A's image in which the illuminance has been increased and transmits the captured image of user A to the cell phone 100B. The cell phone 100B displays the image of user A, the luminance of which has been increased (FIG. 13 (C)). Therefore, it may become possible for the cell phone 100B to display the image of user A which is further increased in luminance.

[Configuration of Cell Phone According to Third Embodiment]

The configuration of the cell phone 100 according to the third embodiment is the same as that of the cell phone according to the second embodiment. In the third embodiment, the cell phone 100 is used by user A for talking with user B utilizing the videophone function. Therefore, the cell phone 100 in the third embodiment is different from that in the second embodiment in the flow of the process to be executed. In the following, the flow of the process according to the third embodiment will be described with respect to points that are different from those in the second embodiment. In the following description, 100A denotes the cell phone that user A uses and 100B denotes the cell phone that user B uses. The same numerals are assigned to the same compositional elements which have been already described and a description thereof will be omitted.

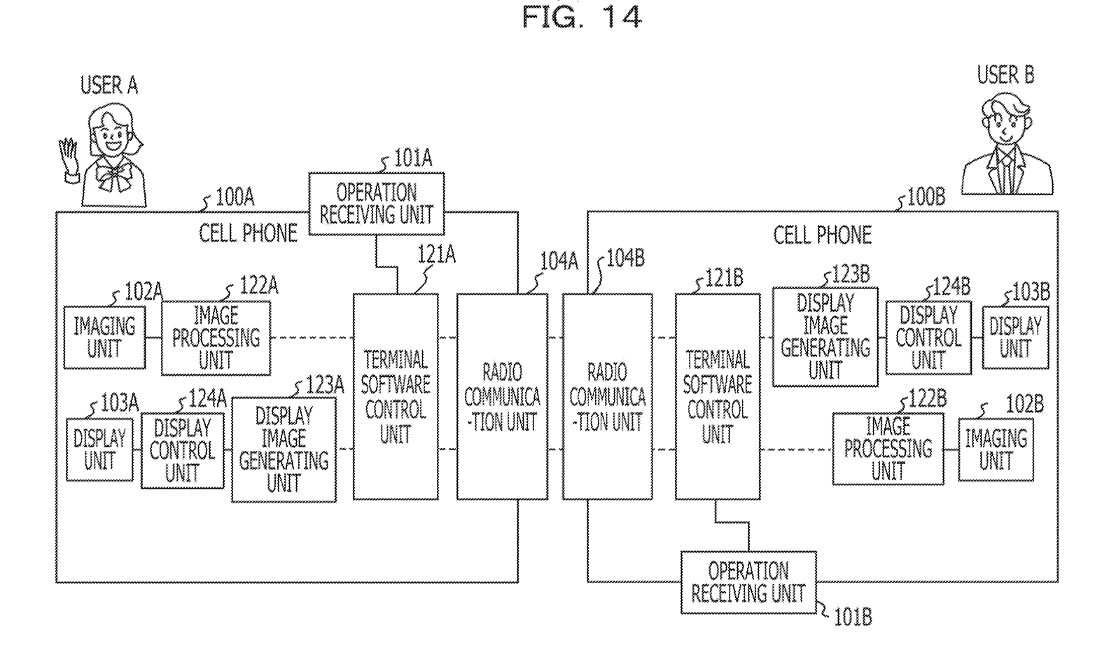

FIG. 14 is a functional block diagram illustrating an example of a configuration of a set of cell phones 100 according to the third embodiment. Although the cell phone A includes a storage unit 110A as in the case with the cell phone in the second embodiment, a description thereof will be omitted for the simplification of explanation. Likewise, although the cell phone 100B includes compositional elements which are the same as those in the cell phone 100A, a description thereof will be omitted. The cell phone 100A is coupled with the cell phone 100B via radio communication.

In the cell phone 100A, an imaging unit 102A captures the image of user A of the cell phone 100A. An image processing unit 122A digitizes the image that the imaging unit 102A has captured. In the example of the second embodiment, the image processing unit 122 transfers the image data to the display image generating unit 123 of the cell phone 100. On the other hand, in the example of the third embodiment, the image processing unit 122A transfers the image data to a display image generating unit 123B of the cell phone 100B. The display image generating unit 123B transfers the image data so transferred to a display control unit 124B to display the image data on a display unit 103B of the cell phone 100B. Thus, the image of user A that the cell phone 100A has captured is displayed on the cell phone 100B of user B.

An image of user B that an imaging unit 102B of the cell phone 100B has captured is displayed on a display unit 103A of the cell phone 100A that user A uses. Thus, the cell phones 100A and 100B mutually display their captured images on the display units, thereby providing videophone functions.

A terminal software control unit 121B receives a light setting from the user B via an operation receiving unit 101B. In the cell phone 100B, the terminal software control unit 121B transmits the image of user B to the cell phone 100A via a radio communication unit 104B and a radio communication unit 104A and simultaneously transfers an instruction to execute a light setting to the cell phone 100A. In the cell phone 100A, when a terminal software control unit 121A receives the instruction to execute a light setting, a display image generating unit 123A generates an image of higher luminance by reducing the transmitted image of user Band whitening the blank space that is made around the reduced image to form a composite image. In the cell phone 100A, the imaging unit 102A captures user A's image in which the illuminance has been increased and transmits the captured image of user A to the cell phone 100B. As a result, it may become possible for the cell phone 100B to display the image of the user that is further increased in luminance on the display unit 103B. On the other hand, in the cell phone 100A, when it has been determined that a light setting has been received, the terminal software control unit 121A transmits the image of user A to the cell phone 100B via the radio communication unit 104A and the radio communication unit 104B, and simultaneously transfers the instruction to execute a light setting to the cell phone 100B. In the cell phone 100B, when the terminal software control unit 121B receives the instruction to execute a light setting, the display image generating unit 123B generates an image of higher luminance by reducing the transmitted image of user A and whitening the blank space that is made around the reduced image to form a composite image. In the cell phone 100B, the imaging unit 102B captures user B's image in which the illuminance has been increased and transmits the captured image of the user B to the cell phone 100A. Thus, it may become possible for the cell phone 100A to display the image of the user B which is further increased in luminance on the display unit 103A.

[Processes that Cell Phones Execute According to Embodiment 3]

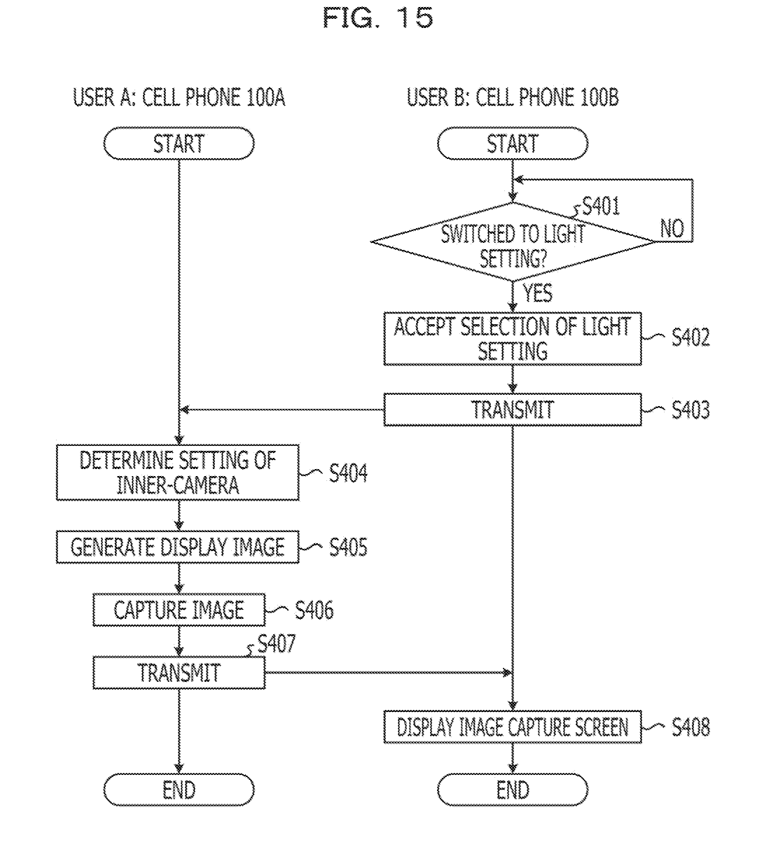

Next, the flow of processes executed using the cell phones 100A and 100B will be described. FIG. 15 is a flowchart illustrating the flow of the processes executed using the cell phones 100A and 100B according to the third embodiment. In the following, for the simplification of explanation, an example will be described in which the luminance of an image of user A that is displayed on the cell phone 100B that user B uses is adjusted while user A and user B are talking with each other.

In the cell phone 100B, when a light setting has been received from the user (step S401, Yes), the terminal software control unit 121B displays the screen for light setting and receive a light setting selection (step S402). The terminal software control unit 121B transmits the received light setting to the cell phone 100A via the radio communication unit 104B (step S403).

In the cell phone 100A, the terminal software control unit 121A determines the light setting which has been received from the cell phone 100B (step S404), and a display image generating unit 123A generates a display image based on the result of the determination (step S405). Specifically, the display image generating unit 123A executes the processes in steps S105 to S112 illustrated in FIG. 8. In the second embodiment, the image of the subject is processed. In the third embodiment, the image which has been transmitted from a caller is processed.

In the cell phone 100A, the imaging unit 102A captures the image of user A by using light of which luminance is provided by the generated image as the light source (step S406). The terminal software control unit 121A transmits the captured image of user A to the cell phone 100B (step S407). In the cell phone 100B, the terminal software control unit 121B displays the transmitted image on the display unit 103B (step S408).

[Effect of Embodiment 3]

As described above, in the cell phone 100A according to the third embodiment, the imaging unit 102A captures the image of user A. The image which has been captured using the imaging unit 102A is displayed on the display unit 103B. The image of user B which has been captured using the imaging unit 102B is displayed on the display unit 103A. The display unit 103A is located so that the exposure range which is exposed with display light radiated from the display area of the display unit 103A, and at least a part of the imaging range within which the imaging unit 102A captures the image may overlap each other. As a result, user A is illuminated with the display light radiated from the display unit 103A. The display image generating unit 123A generates the display image of a luminance which is higher than that of the applicable captured image while maintaining the form of the subject in the image which has been captured using the imaging unit 102B. The display control unit 124A controls the display unit 103A to display the image which has been generated using the display image generating unit 123A so as to have a luminance which is higher than that of the captured image. In the third embodiment, as the luminance of the image which is displayed on the display unit 103A is increased, the illuminance of user A is increased accordingly. Therefore, use of the cell phone 100 according to the third embodiment may make it possible to adjust the luminance of the image of the person with whom the user concerned is talking without the provision of a dedicated light source.

In the example of the third embodiment, the display image generating unit 123A generates the display image by reducing the image which has been captured using the imaging unit 102B to the size conforming to the selection of user B, and whitening the area other than the area in which the reduced image is displayed to form the composite image. Therefore, according to the third embodiment, the luminance may be adjusted in accordance with the selection of user B.

In the example of the third embodiment, the display image generating unit 123A determines whether the luminance of the image which has been captured using the imaging unit 102A is higher than the predetermined threshold value. When it has been determined that the luminance of the captured image is not higher than the predetermined threshold value, the display image generating unit 123A generates a display image by reducing the image which has been captured using the imaging unit 102B and whitening the area other than the area in which the reduced image is displayed to form a composite image until the luminance of the captured image becomes higher than the predetermined threshold value. Therefore, according to the third embodiment, automatic adjustment of the luminance of the image may be possible.

In the explanation of the above mentioned embodiment, the example has been described in which upon receipt of the light setting, the cell phone 100A transmits the image which has been captured using the imaging unit 102A to the cell phone 100B and to instruct the cell phone 100B to process the transmitted image. However, the portable terminal disclosed in the present application is not limited to the above mentioned configuration. For example, the cell phone 100A may operate to transmit an image which has been captured using the imaging unit 102A, and which has been subjected to a reducing process and a white composition process using the display image generating unit 123A to the cell phone 100B to be displayed.

### Embodiment 4

[Program]

The configuration of the cell phone according to each of the above mentioned embodiments may be changed in a variety of ways without departing from the gist of the present invention. For example, the functions of the cell phone 100 illustrated in FIG. 3 may be implemented using software elements and the functions of any respective units may be implemented by executing the software elements using a computer. In the following, an example of a computer which is configured to execute a luminance adjustment program obtained by implementing the functions of the cell phone 100 using software elements will be described.

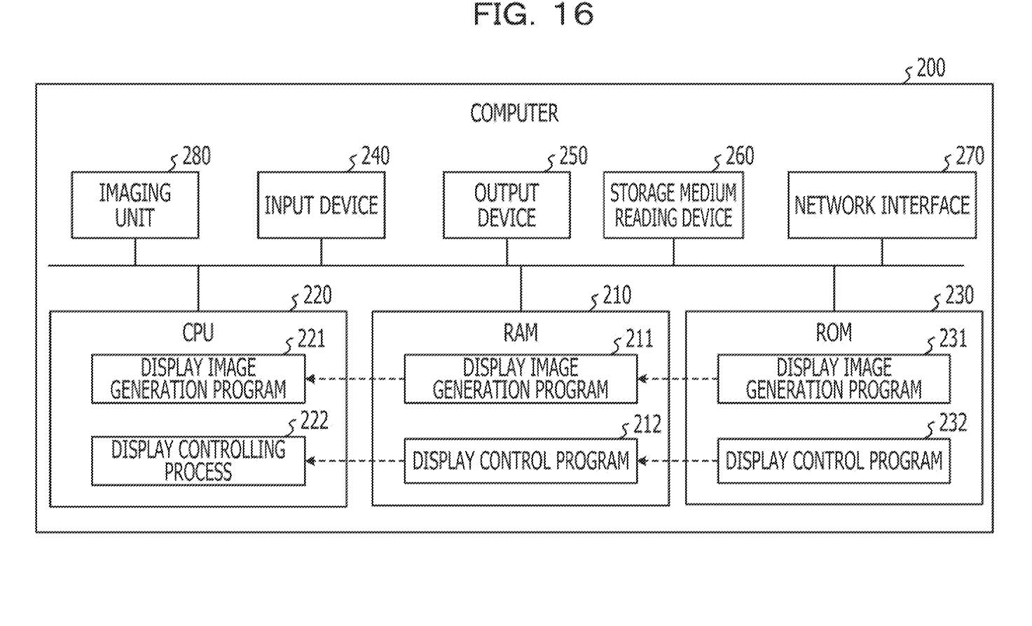

FIG. 16 is a functional block diagram illustrating an example of a configuration of a computer that executes the luminance adjustment program. In FIG. 16, a computer 200 corresponds to the cell phone 100 illustrated in FIG. 3.

The computer 200 includes a CPU (Central Processing Unit) 220 for executing various arithmetic operations, an input device 240 for receiving inputs of various pieces of data from a user, an output device 250 for outputting various pieces of information, and an imaging unit 280. The input device 240 corresponds to the operation receiving unit 101 illustrated in FIG. 3. The output device 250 corresponds to the display unit 103 illustrated in FIG. 3. The imaging unit 280 corresponds to the imaging unit 102 illustrated in FIG. 3.

The computer 200 also includes a medium reading device 260 for reading programs and the like from a storage medium, and a network interface 270 for handling data transmission and reception between the computer 200 and another computer via a network. The network interface 270 corresponds to the radio communication device 104 illustrated in FIG. 3.

The computer 200 further includes a RAM (Random Access Memory) 210 for temporarily storing various kinds of information and a ROM (Read Only Memory) 230 for storing various kinds of information. The RAM 210 and the ROM 230 correspond to the storage unit 110 illustrated in FIG. 3.

A display image generation program 231 which has the same function as the display image generating unit 123 illustrated in FIG. 3 and a display control program 232 which has the same function as the display control unit 124 illustrated in FIG. 3 are stored in the ROM 230. The CPU 220 reads the display image generation program 231 and the display control program 232 from the ROM 230 and expands the read programs in the RAM 210. The CPU executes the display image generation program 211 as a display image generating process 221 and executes the display control program 212 as a display controlling process 222.

The display image generation program 231 and the display control program 232 need not necessarily be stored in the ROM 230 and, for example, may be stored into a storage medium such as a memory card and the like and may be read from the storage medium to be executed. The storage medium comprises all computer-readable storage medium with the sole exception being a transitory, propagating signal. The display image generation program 231 and the display control program 232 may be stored in a storage unit of another computer and may be read from the storage unit via a public line, the Internet, a LAN (Local Area Network), a WAN (Wide Area Network), and the like to be executed.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable terminal having a camera comprising:
a display unit which displays an image captured by the camera, the display unit is located so that an exposure range illuminated with display light of the display unit and at least a part of a capturing range captured by the camera overlap each other;
a display image generating unit which generates a display image having a luminance which is higher than a luminance of the captured image, while maintaining the form of a subject in the captured image; and
a display control unit which controls displaying the display image in the display unit.

2. The portable terminal according to claim 1, wherein
the display image generating unit generates the display image by reducing the captured image and drawing a white image in an area other than an area in which the reduced image is displayed.

3. The portable terminal according to claim 2, wherein
the display image generating unit repeats reducing and drawing the image until the luminance surpasses a threshold value.

4. The portable terminal according to claim 1, wherein
the display unit includes a back light, and
the display control unit controls increasing the luminance of the display image by increasing the current of the back light.

5. A computer-readable storage medium storing a luminance adjustment program which is configured to make a computer having a camera and a display unit that displays an image captured by the camera, the display unit located so that the exposure range illuminated with display light of the display unit and at least a part of an capturing range captured by the camera overlap each other, executes a process comprising:
generating a display image having a luminance which is higher than the luminance of the captured image; and
controlling to display the display image in the display unit.
